(19) United States
(12) Patent Application Publication
(10) Pub. No.: US 2004/0202173 A1
(43) Pub. Date: Oct. 14, 2004

(54) Utopia level interface in ATM multiplexing/demultiplexing assembly

(76) Inventor: Chang Bae Yoon, Uiwang (KR)

Correspondence Address: BAKER & BOTTS, 30 ROCKEFELLER PLAZA, NEW YORK, NY, 10112

(21) Appl. No.: 09/846,949

(22) Filed: May 1, 2001

(30) Foreign Application Priority Data
Jun. 14, 2000 (KR) 2000-32692

(51) Int. Cl. H04L 12/56

(52) U.S. Cl. 370/395.1; 370/474; 370/469

(57) ABSTRACT

There is provided a UTOPIA level interface in an ATM multiplexing/demultiplexing assembly, in which a multiplexer supporting UTOPIA level 2 and a processor supporting UTOPIA level 1 in the ATM multiplexing/demultiplexing assembly of the BIS are constructed of a single electrically programmable logic device (EPLD) to realize high-speed information exchange and simplify the configuration of the assembly. The ATM multiplexing/demultiplexing assembly includes the multiplexer for supporting the UTOPIA level 2 and executing an ATM layer function and the processor for performing the ATM layer function and supporting the UTOPIA level 1. The UTOPIA level interface comprises a UTOPIA interface controller for carrying out an ATM physical layer function to interface the layers of the multiplexer and the processor with each other and for performing level interface between the UTOPIA level 1 and UTOPIA level 2 to provide a 16-bit data path.

### BACKGROUND OF THE INVENTION

1. Field of the Invention

The present invention relates to a base transceiver station interface subsystem (BIS) located in an International Mobile Telecommunication-2000 (IMT-2000) radio network controller, and more particularly, to a UTOPIA (Universal Test and Operations Physical Interface for ATM) level interface in an ATM multiplexing/demultiplexing assembly, in which a multiplexer supporting UTOPIA level 2 and a processor supporting UTOPIA level 1 in the ATM multiplexing/demultiplexing assembly of the BIS are constructed of a single electrically programmable logic device (EPLD) to realize high-speed information exchange and simplify the configuration of the assembly.

2. Description of the Related Art

FIG. 1 shows a configuration of a BIS which is located in a general IMT-2000 radio network controller to interface with an IMT-2000 base transceiver station (BTS). Referring to FIG. 1, a general BIS includes four ATM frame/reframe assemblies (AFDAs) 1-4 each of which dividing an ATM cell transmitted from the BTS into an AAL2-type ATM cell and an AAL5-type ATM cell, and an ATM multiplexing/demultiplexing assembly (AMDA) 10 for multiplexing an ATM cell delivered from the four AFDA 1-4 to send the multiplexed cell to an ATM switch 20 and for demultiplexing an ATM cell transmitted from the ATM switch 20 to deliver it to the four AFDAs 1-4.

The AMDA 10 consists of a processor 14 for carrying out an AAL5 process with respect to the ATM cell transmitted between the four AFDAs 1-4 and the ATM switch 20, an 8-bit cell bus interface 11 for routing the ATM cell through a cell bus between the four AFDAs 1-4 and the AMDA 10, an 8-bit multiplexer 12 for supporting UTOPIA level 1, performing an ATM layer function and dividing the ATM cell transmitted from the 8-bit cell bus interface 11 into a cell to be delivered to the processor 14 and a cell to be sent to the ATM switch 20, a layer converter 13 for executing conversion between an ATM layer and a physical layer to allow the ATM cell transmitted from the 8-bit multiplexer 12 to be AAL5-processed by the processor 14, and 8-bit user-network interfaces (UNIs) 15 and 16 for interfacing the 8-bit multiplexer 12 and the ATM switch 20 with each other at 155 Mbps.

Referring to FIG. 2, the layer converter 13 includes an 8-bit layer converting unit 13a for carrying out physical layer interface between the 8-bit multiplexer 12 and the processor 14, and an 8-bit transmission FIFO 13b and an 8-bit reception FIFO 13c for temporarily storing 8-bit data transmitted/received between the 8-bit multiplexer 12 and the processor 14.

In the conventional AMDA constructed as above, the 8-bit multiplexer 12 and the processor 14 respectively perform the ATM layer function. Thus, they require the layer converter 13 for executing the physical layer function capable of interfacing the two ATM layer functions they carry out with each other. Furthermore, the layer converter 13 was not needed to perform a separate UTOPIA level interface because both the 8-bit multiplexer 12 and the processor 14 supported the UTOPIA level 1 function. However, the AMDA including the 8-bit multiplexer 12 supporting only the UTOPIA level 1 function could not increase traffic processing capacity any more. Accordingly, transmission of information cannot be carried out at a high speed in the AMDA of the IMT-2000 radio network controller so that it was difficult to provide services at a high speed. To solve this problem, a multiplexing device of the AMDA is constructed to support UTOPIA level 2 so as to increase the UNIs. By doing so, the traffic carrying capacity can be improved and messages can be transmitted at a high speed. In this case, however, interface between the UTOPIA level 2 and UTOPIA level 1 cannot be made with the configuration and function of the conventional layer converter.

### SUMMARY OF THE INVENTION

It is, therefore, an object of the present invention to provide a UTOPIA level interface in an ATM multiplexing/demultiplexing assembly, in which a multiplexer supporting UTOPIA level 2 and a processor supporting UTOPIA level 1 in the ATM multiplexing/demultiplexing assembly of the BIS are constructed of a single EPLD to realize high-speed information exchange and simplify the configuration of the assembly.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawing, in which like reference symbols indicate the same or the similar components, wherein:

FIG. 1 is a block diagram of a BIS of a general IMT-2000 radio network controller;

FIG. 2 is a block diagram of the interface between the multiplexer and the processor of FIG. 1;

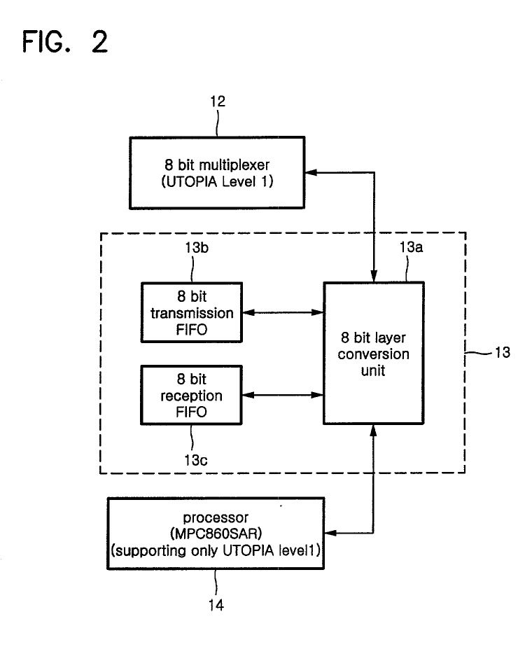

FIG. 3 is a block diagram of a BIS of an IMT-200 radio network controller according to the present invention;

FIG. 4 illustrates a configuration of an embodiment of the UTOPIA interface controller of FIG. 3;

FIG. 5 is a timing diagram of signals when data is transmitted from the processor to the UTOPIA level conversion/control unit of FIG. 3;

FIG. 6 is a timing diagram of signals when data is transmitted from the UTOPIA level conversion/control unit to the processor of FIG. 3;

FIG. 7 is a timing diagram of signals when data is transmitted from the multiplexer to the UTOPIA level conversion/control unit; and

FIG. 8 is a timing diagram of signals when data is transmitted from the UTOPIA level conversion/control unit to the multiplexer of FIG. 3.

### DETAILED DESCRIPTION OF THE PREFERRED EMBODIMENT

A UTOPIA level interface in an ATM multiplexing/demultiplexing assembly (AMDA) according to the present invention is explained below in detail with reference to the accompanying drawings.

The present invention designs an EPLD for interfacing between a multiplexer and two ports using a UTOPIA level 2 interface and an MPC860 processor in an AMDA to perform conversion between UTOPIA levels and conversion between an ATM layer and physical layer, simultaneously. In addition, a generic flow control (GFC) field in the header of an ATM cell is used to recognize a port in case of conversion of the UTOPIA level. This technique can be applied to a selector/transcoder interface assembly (STIA) of an ATM multiplexing/demultiplexing subsystem (AMS).

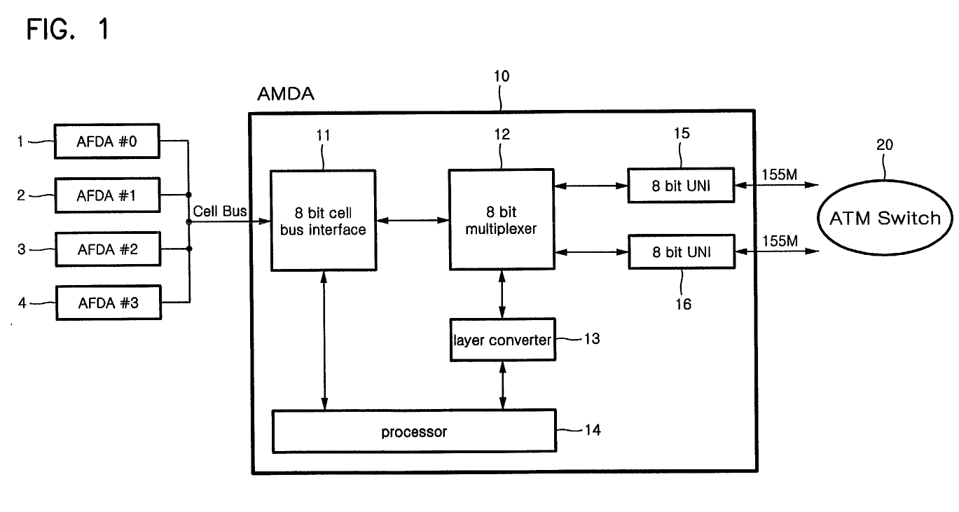

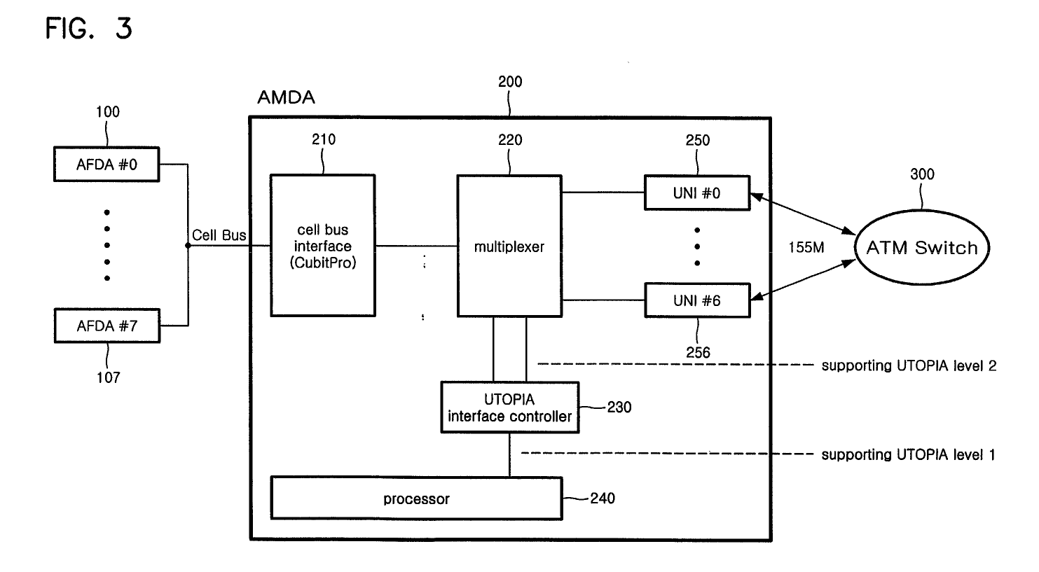

FIG. 3 is a block diagram of a BIS of an IMT-2000 radio network controller to which the present invention is applied. Each of AFDAs 100-107 performs the same function as that of the AFDA shown in FIG. 1 (but eight AFDAs are included in the BIS of the invention). A multiplexer 220 supports the UTOPIA level 2 function, performs the ATM layer function and multiplexes/demultiplexes an ATM cell transmitted between a cell interface 210 and UNIs 250 and 256 and an ATM cell used in an inner processor 240. The processor 240 carries out the ATM layer function to control the AMDA 200 and supports the UTOPIA level 1 function. A UTOPIA interface controller 230 performs an ATM physical layer function to layer-interface the multiplexer 220 and the processor 240 with each other, and executes interfacing between the UTOPIA level 1 and UTOPIA level 2 to provide a 16-bit data path.

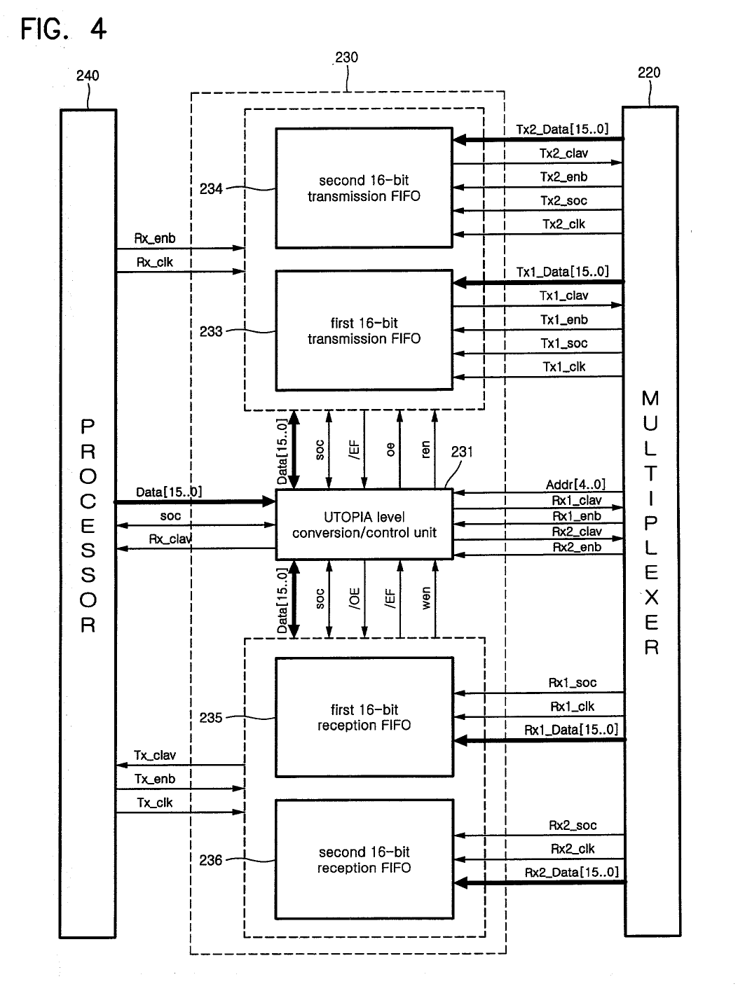

Referring to FIG. 4, the UTOPIA interface controller 230 includes 16-bit transmission FIFOs 233 and 234 and 16-bit reception FIFOs 235 and 236 for temporarily storing data transmitted/received between the multiplexer 220 and the processor 240, and a UTOPIA level conversion/control unit 231 for transmitting/receiving a UTOPIA level 2 control signal to/from the multiplexer 220 to allow 16-bit data to be transmitted/received between the multiplexer 220 and the 16-bit transmission FIFOs 233 and 234 and 16-bit reception FIFOs 235 and 236 and for transmitting/receiving a UTOPIA level 1 control signal to/from the processor 240 to allow 16-bit data to be transmitted/received between the processor 240 and the 16-bit transmission FIFOs 233 and 234 and 16-bit reception FIFOs 235 and 236.

The operation of the interface between the UTOPIA level 2 execution unit and UTOPIA level 1 execution unit in the AMDA according to the present invention is described below with reference to the attached drawings.

The first 16-bit transmission FIFO 233 and the second 16-bit transmission FIFO 234 temporarily store 16-bit data received from an ATM layer function execution unit, that is, the multiplexer 220 and the processor 240. The UTOPIA level conversion/control unit 231 performs the physical layer function. The first 16-bit reception FIFO 235 and the second 16-bit reception FIFO 236 temporarily store 16-bit data received from a physical layer function execution unit, that is, the UTOPIA level conversion/control unit 231.

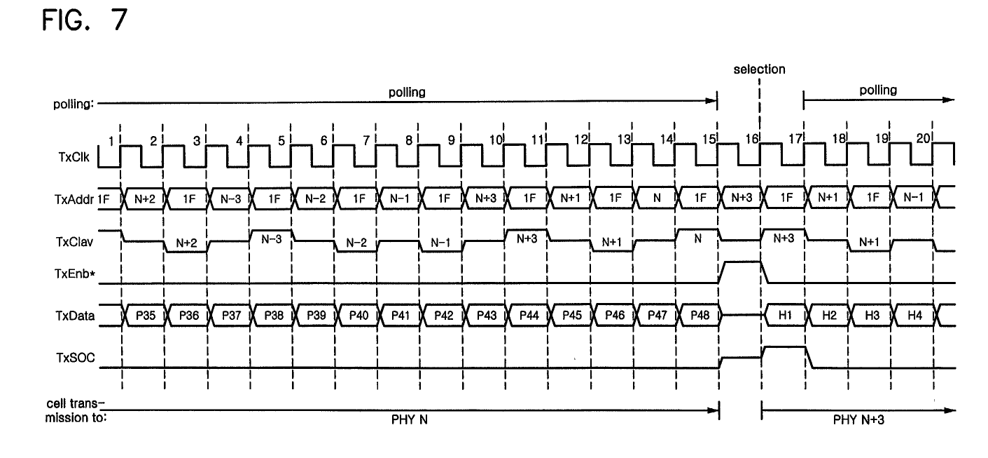

First of all, there is explained transmission of 16-bit data from the multiplexer 220 (ATM layer) to the UTOPIA level conversion/control unit 231 (physical layer). If an input ATM cell is a cell to be transmitted to the processor 240 of the AMDA 200, the multiplexer 220 checks a generic flow control (GFC) field in the header of the ATM cell to judge which port the ATM cell will enter, and exhibits an address TxAddr of a corresponding port as shown in FIG. 7. Then, the UTOPIA level conversion/control unit 231 decodes the address for designating the corresponding port to transmit a signal TxClav at an active high level that informs that a corresponding 16-bit transmission FIFO has a space for receiving the ATM cell to the multiplexer 220.

Here, the multiplexer 220 transmits a signal TxEnb* at an active low level which informs that 16-bit transmission data Txdata includes effective data, and delivers a signal TxSOC informing that the data Txdata contains the first effective byte of the cell, thereby sending the 16-bit data Txdata through the 16-bit transmission FIFO. Here, it is possible to deliver the data or temporarily stop the transmission of the data according to the signal TxEnb*.

Reception of 16-bit data by the multiplexer 220 (ATM layer) from the UTOPIA level conversion/control unit 231 (physical layer) will be explained below.

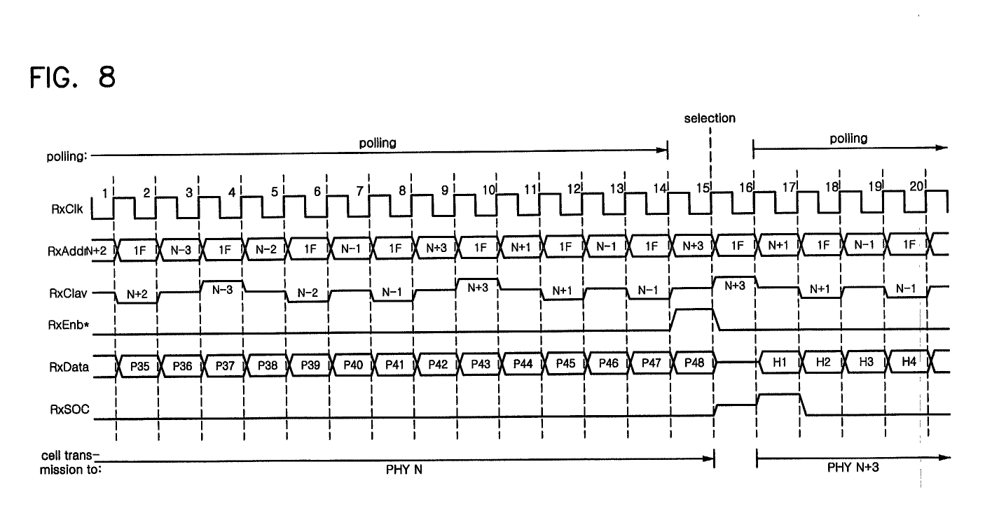

When the ATM layer (multiplexer 220) detects that the 16-bit reception FIFO is filled while watching the physical layer port, it exhibits an address RxAddr as shown in FIG. 8. The UTOPIA level conversion/control unit 231 informs the ATM layer function execution unit (multiplexer 220) that the 16-bit reception FIFO has the data using a signal RxClav. The multiplexer 220 makes a signal Rx_enb which informs that data Rxdata includes effective cell data, starts to receive the 16-bit data Rxdata, and gives a signal Rx_soc informing the starting point of the header of the data. By doing so, the multiplexer 220 can receive the 16-bit data, being interfaced with the UTOPIA level 2, from the UTOPIA level conversion/control unit 231.

Next, transmission of 16-bit data from the processor 240 (ATM layer) to the UTOPIA level conversion/control unit 231 (physical layer) is described below.

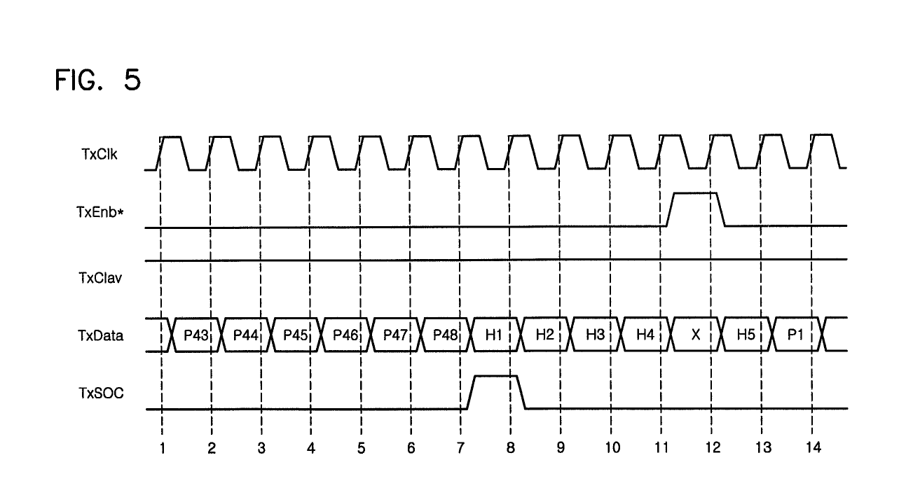

First of all, the processor 240 checks the GFC in the ATM cell header to judge which port the cell enters, and inputs the data to a corresponding 16-bit reception FIFO. Then, the transmission operation starts when a signal Tx_Clav informing that the 16-bit reception FIFO has a space for receiving the data becomes the active high level, as shown in FIG. 5. The processor 240 outputs a signal Tx_enb* at an active low level, 16-bit data Rxdata is transmitted in synchronization with a clock Rxclk, and a signal Tx_soc indicating the cell header becomes the active high level. By doing so, the processor 240 can transmit the 16-bit data, being interface with the UTOPIA level 1, to the UTOPIA level conversion/control unit 231. Here, it is possible to deliver the data or temporarily stop the transmission of the data according to the signal TxEnb*.

Finally, reception of 16-bit data by the processor 240 (ATM layer) from the UTOPIA level conversion/control unit 231 (physical layer) is explained below.

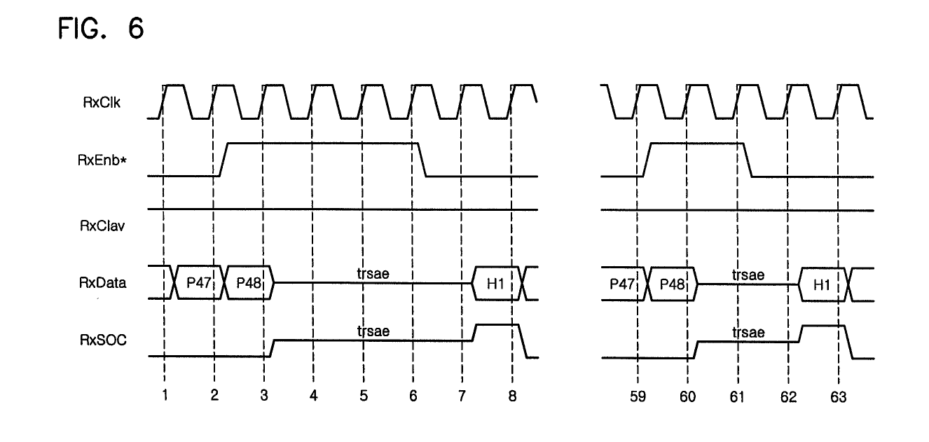

As shown in FIG. 6, the UTOPIA level conversion/control unit 231 transmits a signal RxClav informing that a corresponding 16-bit reception FIFO has 16-bit data to be delivered to the processor 240. Then, the processor 240 outputs a signal RxEnb* at the active low level, starts to receive the 16-bit data and gives a signal RxSOC informing the starting point of the header of the data. By doing so, the processor 240 can receive the 16-bit data, being interfaced with the UTOPIA level 1, from the UTOPIA level conversion/control unit 231.

According to the present invention, as described above, the multiplexer supporting the UTOPIA level 2 and the processor supporting the UTOPIA level 1 in the ATM multiplexing/demultiplexing assembly of the BTS interface subsystem can be constructed of a single electrically programmable logic device to realize high-speed information exchange and to simplify the configuration of the apparatus.

Although specific embodiments including the preferred embodiment have been illustrated and described, it will be obvious to those skilled in the art that various modifications may be made without departing from the spirit and scope of the present invention, which is intended to be limited solely by the appended claims

What is claimed is:

1. A UTOPIA level interface in an ATM multiplexing/demultiplexing assembly in a base transceiver station interface subsystem in an IMT-2000 radio network controller, the ATM multiplexing/demultiplexing assembly including a UTOPIA level 2 execution unit (multiplexer) for supporting UTOPIA level 2 and executing an ATM layer function and a UTOPIA level 1 execution unit (processor) for performing the ATM layer function and supporting UTOPIA level 1, the UTOPIA level interface comprising a UTOPIA interface controller for carrying out an ATM physical layer function to interface the layers of the multiplexer and the processor with each other and for performing level interface between the UTOPIA level 1 and UTOPIA level 2 to provide a 16-bit data path.

2. The UTOPIA level interface in an ATM multiplexing/demultiplexing assembly as claimed in claim 1, wherein the UTOPIA interface controller includes transmission and reception FIFOs for temporarily storing data to be transmitted/received between the multiplexer and the processor, and a UTOPIA level conversion/control unit for transmitting/receiving a UTOPIA level 2 control signal to/from the multiplexer to allow the 16-bit data to be transmitted between the multiplexer and the transmission and reception FIFOs and for transmitting/receiving a UTOPIA level 1 control signal to/from the processor to allow the 16-bit data to be transmitted between the processor and the transmission and reception FIFOs.

3. The UTOPIA level interface in an ATM multiplexing/demultiplexing assembly as claimed in claim 2, wherein the transmission FIFO includes two 16-bit transmission FIFOs.

4. The UTOPIA level interface in an ATM multiplexing/demultiplexing assembly as claimed in claim 2, wherein the reception FIFO includes two 16-bit reception FIFOs.
